(19) United States
(12) Patent Application Publication
(10) Pub. No.: US 2002/0169913 A1
(43) Pub. Date: Nov. 14, 2002

(54) System and method of switching a hot-pluggable peripheral device

(76) Inventors: Stephen D. Heizer, Houston, TX (US); Michael D. Batchelor, Tomball, TX (US)

Correspondence Address: Diana M. Sangalli, Fletcher, Yoder & Van Someren, P.O. Box 692289, Houston, TX, 77269-2289, US

(21) Appl. No.: 09/852,981

(22) Filed: May 10, 2001

(51) Int. Cl. G06F 13/38

(52) U.S. Cl. 710/302

(57) ABSTRACT

A processor-based device includes a hot-plug capability which permits a peripheral device to be connected to the processor-based device without first removing power. The hot plug capability is implemented by a control circuit in the processor-based device which controls the application of power to the peripheral device in response to a device detect signal provided by the peripheral device when it is connected to the processor-based device. The control circuit also monitors the voltage applied to the power rail for the peripheral device. When the voltage on the peripheral device power level reaches a threshold, the control signal provides a signal indicating that the processor-based device may access the peripheral device.

### BACKGROUND OF THE INVENTION

1. Field of the Invention

The present invention relates generally to hot-pluggable peripheral devices and, more particularly, to a system and method of connecting and disconnecting a peripheral device to a main system device while system power is applied.

2. Background Of The Related Art

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

A variety of processor-based electronic devices, such as servers, desktop computers, laptop computers, handheld computers, cellular telephones, personal digital assistants (PDAs), and Internet appliances, are becoming increasingly prevalent in today's information age. Such devices generally include an operating system and various software programs to accommodate many types of computing functions, such as data processing, scheduling, word processing, Internet access, caller identification, call forwarding, telephone number storage, etc.

As use of processor-based devices has increased, manufacturers have begun to offer an abundance of add-on features which enhance the versatility of the devices. Such add-on features often are provided in the form of a peripheral device or an option pack having a specific function, which may be connected to the main processing unit via an appropriate interface connector. To add to the convenience of using an add-on device, the main processing unit may be designed such that the add-on device is “hot-pluggable,” meaning that it may be connected and disconnected from the main unit without removing system power and/or resetting the main unit.

The “hot plug” capability may be problematic in some units, as it typically introduces electrical anomalies (e.g., voltage spikes, voltage dropouts, current surges), which potentially may cause operational errors or damage components in either the main unit or the add-on peripheral device. The electrical anomalies also may include multiple, momentary transient signals during connection of the peripheral device that result in erroneous feedback signals provided to the main unit that improperly indicate that the peripheral device is connected and fully powered. If such a signal is sent to the main unit before full voltage has been applied to the peripheral device, the main unit may attempt to access the peripheral device before the peripheral device is ready. This premature access attempt may result in operational errors that may require a system power down and reset of the main unit or disconnection and re-connection of the peripheral device.

The present invention may be directed to one or more of the problems set forth above.

### BRIEF DESCRIPTION OF THE DRAWINGS

The foregoing and other advantages of the invention may become apparent upon reading the following detailed description and upon reference to the drawings in which:

FIG. 1 illustrates a block diagram showing a peripheral device that is connectable to a main processing unit;

FIG. 2 illustrates a block diagram of the main processing unit and the hot pluggable peripheral device of FIG. 1, including hot-plug control circuitry in accordance with the invention;

FIG. 3 is an electrical schematic illustrating an exemplary embodiment of the hot-plug control circuitry of FIG. 2; and

FIG. 4 illustrates a flow chart, representing operation of the hot-plug control circuitry of FIGS. 2 and 3, when the peripheral device is hot-plugged to the main processing unit.

### DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

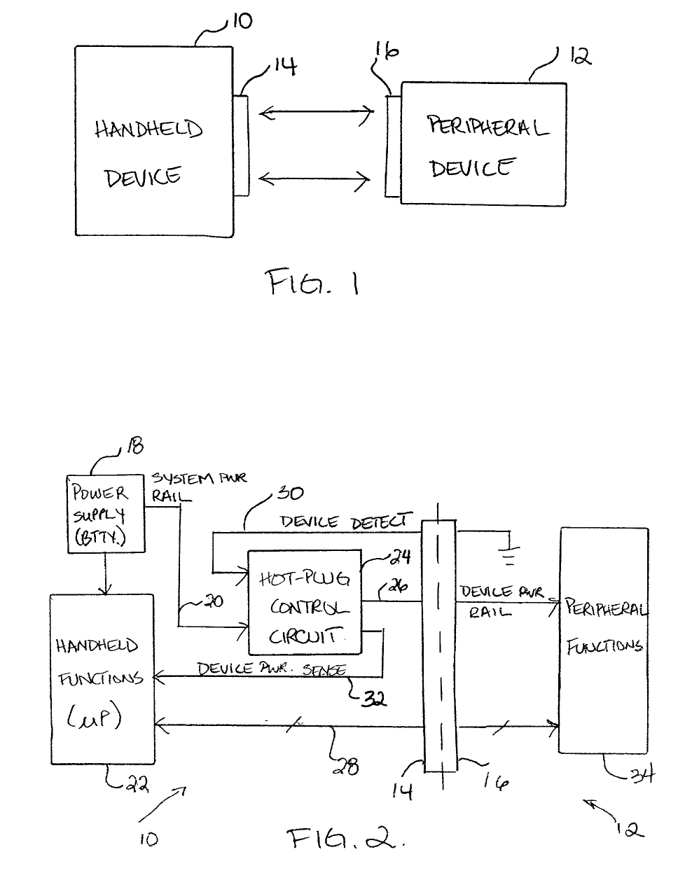

Turning now to the drawings, and referring generally to FIG. 1, a block diagram representing a main processing unit 10 that is connectable to a peripheral device 12 is illustrated. The main unit 10 may be any of a variety of processor-based devices, such as personal digital assistants (PDAs), desktop computers, laptop computers, handheld computers, servers, Internet appliances, cellular telephones, etc., which offer computing capabilities or functions (e.g., data processing, scheduling, address/telephone number referencing, word-processing, paging, caller identification, Internet access, etc.) under control of a processor that executes program code stored in memory. In addition to a user interface, one or more processors, and memory devices (not shown), the main unit 10 includes a peripheral connector 14 configured for connection to a mating connector 16 of the peripheral device 12. The main unit 10 is provided with a hot-plug feature, meaning that the peripheral device 12 may be connected to the main unit 10 without powering down or resetting the unit 10.

The peripheral device 12 may be any device suitable for connection with the main unit 10. For example, if the main unit 10 is a PDA, the peripheral device 12 may be any one of a variety of option packs which provide specific add-on features or functions, such as additional memory, additional storage, additional battery life, a wireless modem, a magnetic stripe card reader, a word-processing application, a spread-sheet application, etc. If the main unit 10 is a desktop or laptop computer, the peripheral device 12 may be, for example, a hard drive, CD ROM drive, modem, etc. Peripheral devices are particularly useful as they enable a streamlined design of the main system unit 10, while allowing the user to select optional features that are particularly suited to the user's needs or to add new or enhanced features as the user's needs change. Further, the ability to hot-plug the peripheral device with the main unit provides enhanced versatility, because the user easily can connect or swap peripheral devices without powering down or resetting the main unit 10.

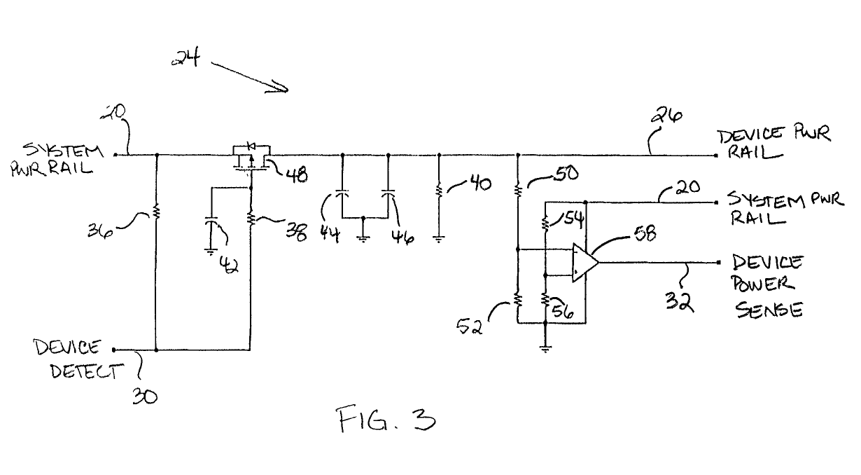

FIG. 2 illustrates a block diagram of the main unit 10 connected to the peripheral device 12 via the connectors 14 and 16. As shown, the main unit 10 includes a power supply circuit 18 (which may include a battery) to provide power to a system power rail 20, main functions 22 (e.g., data processing, scheduling, word processing, telephone functions, etc.) executed under control of a processor (e.g., a microcontroller, a microprocessor, etc.), and a hot plug control circuit 24 disposed between the system power rail 20 and a device power rail 26 that enables the peripheral device 12 to be “hot-plugged” to the main processing unit 10.

When a peripheral device 12 is hot-plugged to a main unit 10, several electrical anomalies which affect operation of the unit 10 and the device 12 may occur if the application of power from the system rail 20 to the device rail 26 is not controlled. For example, applying power to the device rail 26 directly from the system rail 20 may result in a current surge which causes a voltage droop on the system rail 20. If the droop is large enough, inadequate voltage may be applied to the main unit components, resulting in improper or erroneous operation. Further, the current surge itself may damage components if not maintained within safe operating ranges. Still further, the act of mating connectors 14 and 16 causes multiple, temporary “make and break” contacts, which also can produce electrical signals that cause operational errors. For example, such an erroneous signal may indicate to the main unit 10 that the peripheral device 12 is connected and fully powered before the voltage on the device power rail 26 has stabilized at the desired voltage level. This indication may cause the main unit 10 to attempt prematurely to access the peripheral device 12 via a bus 28 (e.g., a serial peripheral interface bus, a SCSI bus, an IDE bus, etc.), resulting in an error that may require disconnection and reconnection of the peripheral device 12.

The hot-plug control circuit 24 illustrated in FIG. 2 addresses problems associated with the hot plug capability. The hot plug control circuit 24 controls the application of power from the system power rail 20 to the device power rail 26 in response to receipt of a device detect signal 30 received when the peripheral device 12 is connected to the main unit 10. In an exemplary embodiment, the device detect signal 30 is provided by connecting a pin of the peripheral device connector 16 to ground in the peripheral device 12. Thus, when the peripheral device 12 is connected to the main unit 10, a logical LOW level signal 30 (i.e., the device detect signal) is provided to the hot-plug control circuit 24, indicating that the presence of the peripheral device 12 has been detected.

The hot-plug control circuit 24 also monitors the device power rail 26 to determine when the voltage level is at a proper level to ensure that the peripheral device 12 will operate properly. Thus, when the voltage level on power rail 26 equals or exceeds a threshold level (e.g., 3V), the hot-plug control circuit 24 provides a device power sense signal 32 to the main functions 22 indicating that the main unit 10 now may access the peripheral functions 34 (e.g., storage, Internet access, word processing, etc.) of the peripheral device 12.

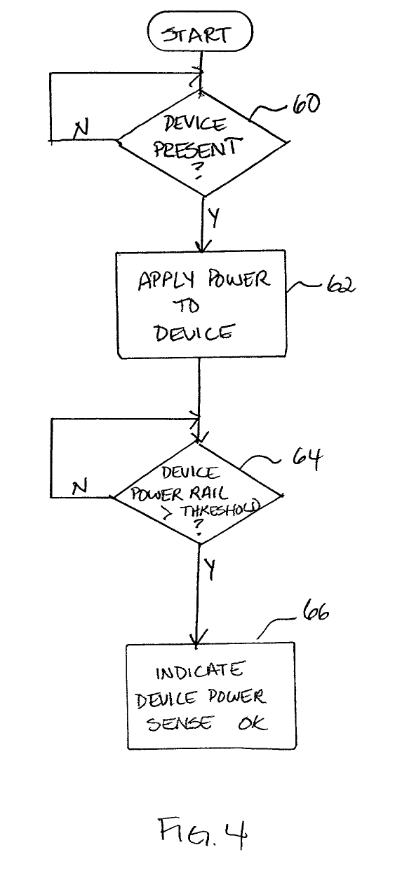

FIG. 3 illustrates an electrical schematic of an exemplary embodiment of the hot plug control circuit 24. As discussed above, the circuit 24 includes a system power rail input 20, a device detect input 30, a device power rail output 26, and a device power sense output 32. The circuit 24 controls the application of power from the system power rail input 20 to the device power rail 26 in response to a device detect signal received on the device detect input 30. As the voltage comes up on the device power rail 26, the circuit 24 monitors the voltage level to determine when the voltage applied to the peripheral device 12 is at a level (e.g., 3V) sufficient to ensure proper operation. When this level is reached, the circuit 24 provides a device power sense signal 32, thus enabling the main function circuitry 22 to access the peripheral device functions 34.

The hot-plug control circuit 24 further is configured to provide high frequency filtering near the peripheral device connector 14 for filtering high frequency signals on the device power rail 26 that may be caused by momentary “makes and breaks” during the hot-plug insertion process or which are introduced during steady state operation from the environment or operation of the main unit 10.

The application of power from the system rail 20 to the device rail 26 in response to the device detect signal 30 is implemented via resistors 36, 38, and 40, capacitors 42, 44, and 46, and transistor 48 (e.g., a p-channel FET). When the peripheral device 12 is not connected to the main unit 10, the device detect input 30 and the gate of transistor 48 are pulled to the system rail 20 voltage through the resistors 36 and 38. While in this condition, the transistor 48 is in a non-conductive state, and the capacitor 42 has been fully charged through the series combination of the resistors 36 and 38. Further, the device power rail 26 is pulled to ground through the resistor 40, thus completely discharging the capacitors 44 and 46.

When the peripheral device 12 is connected to the main unit 10 via the device connectors 14 and 16, the device detect input 30 is pulled to ground by a connection in the peripheral device 12. The capacitor 42 begins to discharge through the resistor 38, thus gradually transitioning the transistor 48 to a fully conductive state and causing the voltage on the device power rail 26 to gradually rise. When the capacitor 42 is fully discharged, the gate of the transistor 48 is pulled to ground through the resistor 38, thus placing the transistor 48 in a steady-state, fully conductive state. In this condition, the full voltage from the system power rail 20 is applied to the device power rail 26, and the capacitors 44 and 46 are fully charged. The capacitors 44 and 46 are sized to act as high frequency filters to prevent noise from the system rail 30 from passing onto the device power rail 26 and potentially causing errors in the operation of the peripheral device 12.

During the period in which the transistor 48 is transitioning from a non-conductive state to a fully conductive state, the amount of current that may be provided to the device power rail 26 is limited because, until the gate threshold voltage is reached, the transistor 48 is only partially conductive. This controlled application of power to the device power rail 26 reduces the amount of voltage droop on the system power rail 20 that may otherwise occur as the system power supply collapses due to the current surge that could occur when the peripheral device 12 is connected to the main unit 10.

The hot-plug control circuit 24 also includes resistors 50, 52, 54, and 56, and differential sense amplifier 58 to monitor the rise of the voltage on the device power rail 26 and to generate a device power sense signal 32 when the voltage reaches a threshold level. The device power sense signal 32 is provided to the main functions 22, thus enabling the main unit 10 to access the peripheral device functions 34. Thus, premature attempts to access the peripheral device 12 are curtailed, avoiding potential operational errors that may require removal and re-connection of the peripheral device 12 to the main unit 10.

To determine whether the voltage on the device power rail 26 has reached a sufficient level to ensure proper operation, the differential amplifier 58 compares the device power rail voltage to a reference voltage derived from the system power rail 20. The device power rail 26 voltage is provided to the negative input of the amplifier 58 through the voltage divider (resistor 52)/(resistor 50+resistor 52). The reference voltage is provided to the positive input of the differential amplifier 58 from the system power rail 20 through the voltage divider (resistor 56)/(resistor 54+resistor 56).

When a peripheral device 12 is not connected to the main unit 10, the negative input of the differential amplifier 58 is grounded through the resistor 52 in parallel with the series combination of resistors 40 and 50, and the positive input of amplifier 58 receives the reference voltage derived from the system power rail 20. Thus, the positive input of the amplifier 58 is at a higher level than the negative input, allowing the output 32 (i.e., the device power sense signal) to be pulled high by a pull-up resistor (not shown) in the main unit 10. Thus, the device power sense signal 32 is at a logical HIGH level when a peripheral device 12 is not connected to the main unit 10.

When a peripheral device 12 is connected, the voltage on the device power rail 26 rises in a controlled manner, as discussed above. Thus, correlative to the relationship between the voltage dividers on the negative and positive inputs of the amplifier 58, the voltage provided to the negative input eventually reaches and passes the reference voltage set by the positive input voltage divider. When this condition occurs, the amplifier 58 pulls its output 32 to ground, thus providing a logical LOW level device power sense signal 32 to the main functions 22, signifying that peripheral accesses now are permitted.

The value of the reference voltage and the relationship between the positive input voltage divider and negative input voltage divider are a matter of design choice governed by the electrical requirements of the components in the peripheral device 12 which derive power from the device power rail 26. Thus, the selection of resistor values and reference voltage values would be readily apparent to those of ordinary skill in the art. Likewise, selection of specific values for the other components illustrated in FIG. 3 are design choices that would be readily apparent to those of ordinary skill in the art.

Turning now to FIG. 4, a flow chart illustrating the logical operation of the hot-plug control circuit 24 is provided. The control circuit 24 determines whether a peripheral device 12 is connected to the main unit 10 (block 60), e.g., by detecting a Device Detect signal. If a peripheral device 12 is present, then the control circuit 24 allows power to be provided to the peripheral device 26 in a controlled manner (block 62). The control circuit 24 monitors the device power rail 26 as power is being applied to determine when the voltage on the device rail 26 has reached a threshold level (block 64). When the threshold is reached, the control circuit 24 provides a Device Power Sense signal 32 to the main functions 22, indicating that the peripheral device 12 may be accessed (block 66).

While the foregoing description has described specific signals that are provided to and generated by the hot-plug control circuit, it should be understood that many different implementations of the control circuit are contemplated. Such implementations may receive and generate different types of signals or signals having logical levels other than those described above. Further, the control circuit may control application of power to the peripheral device in different manners, such as by directly controlling the rate of rise of voltage on the device power rail. Alternatively, the control circuit may limit the amount of current or the rate of rise of the current provided to the peripheral device in a manner other than by controlling the rate of turn-on of a conductive device.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A processor-based device, comprising:
a power supply to generate power for the processor-based device;
a peripheral connector to connect to a peripheral device; and
a control circuit coupled to the power supply and the peripheral connector, the control circuit being configured to control application of power from the power supply to the peripheral device when the peripheral device is connected to the peripheral connector while the power supply is generating power.

2. The processor-based device as recited in claim 1, wherein the control circuit is configured to disable access from the processor-based device to the peripheral device until voltage applied to the peripheral device from the power supply reaches a predetermined threshold.

3. The processor-based device as recited in claim 1, wherein the control circuit is configured to monitor voltage applied to the peripheral device from the power supply and to enable access from the processor-based device to the peripheral device when the voltage reaches a predetermined threshold.

4. The processor-based device as recited in claim 1, wherein the control circuit receives a signal from the peripheral device when the peripheral connector is connected to the peripheral device, and wherein the control circuit is configured to control application of power to the peripheral device in response to the signal.

5. The processor-based device as recited in claim 1, wherein the power supply comprises a battery.

6. The processor-based device as recited in claim 1, comprising a processor in communication with the control circuit.

7. The processor-based device as recited in claim 1, wherein the processor-based device is a personal digital assistant.

8. The processor-based device as recited in claim 1, wherein the processor-based device is a desktop computer.

9. The processor-based device as recited in claim 1, wherein the processor-based device is a laptop computer.

10. The processor-based device as recited in claim 1, wherein the processor-based device is a server.

11. The processor-based device as recited in claim 1, wherein the processor-based device is an Internet appliance.

12. The processor-based device as recited in claim 1, wherein the processor-based devices is a cellular telephone.

13. A method for hot-plugging a peripheral device to a processor-based device, the method comprising the acts of:
detecting connection of a peripheral device to a processor-based device while the processor-based device is powered; and
controlling application of power from the processor-based device to the peripheral device in response to detecting connection.

14. The method as recited in claim 13, comprising the acts of:
monitoring voltage applied to the peripheral device while controlling application of power; and
enabling access from the processor-based device to the peripheral device when the monitored voltage reaches a predetermined threshold.

15. The method as recited in claim 13, comprising the act of:
monitoring voltage applied to the peripheral device while controlling application of power; and
prohibiting access from the processor-based device to the peripheral device until the monitored voltage reaches a predetermined threshold.

16. The method as recited in claim 13, wherein the act of controlling application of power comprises the act of limiting rise of voltage applied to the peripheral device from the processor-based device.

17. The method as recited in claim 13, wherein the act of controlling application of power comprises the act of limiting rise of current supplied from the processor-based device to the peripheral device.

18. The method as recited in claim 13, comprising the act of connecting the peripheral device to the processor-based device.

19. The method as recited in claim 13, wherein the processor-based device is a desktop computer.

20. The method as recited in claim 13, wherein the processor-based device is a personal digital assistant.

21. The method as recited in claim 20, wherein the peripheral device is an option pack.

22. The method as recited in claim 13, wherein the peripheral device comprises a storage device.

23. A processor-based system, comprising:
a processor-based device; and
a peripheral device comprising a first peripheral connector for coupling with the processor-based device,
wherein the processor-based device comprises:
a power supply to generate power for the processor-based device;
a second peripheral connector configured to connect to the first peripheral connector; and
a control circuit coupled to the power supply and the first peripheral connector, the control circuit being configured to control application of power from the
power supply to the peripheral device when the first peripheral connector is connected to the second peripheral connector while the power supply is generating power.

24. The system as recited in claim 23, wherein the control circuit is configured to limit rise of voltage applied to the peripheral device from the processor-based device.

25. The system as recited in claim 23, wherein the control circuit is configured to limit rise of current provided from the processor-based device to the peripheral device.

26. The system as recited in claim 23, wherein, while the control circuit is controlling application of power to the peripheral device, the control circuit is configured to monitor voltage applied to the peripheral device from the processor-based device and to disable access from the processor-based device to the peripheral device until the voltage reaches a predetermined threshold.

27. The system as recited in claim 23, wherein the peripheral device is configured to provide a signal to the control circuit upon connection of the first peripheral connector to the second peripheral connector, and wherein the control circuit is configured to initiate application of power to the peripheral device in response to the signal.

28. The system as recited in claim 23, wherein the processor-based device comprises a personal digital assistant.

29. The system as recited in claim 23, wherein the processor-based device comprises a desktop computer.

30. The system as recited in claim 23, wherein the processor-based device comprises a server.

31. The system as recited in claim 23, wherein the processor-based device comprises an Internet appliance.

32. The system as recited in claim 23, wherein the processor-based device comprises a handheld computer.

33. The system as recited in claim 23, wherein the processor-based device comprises a cellular telephone.

34. The system as recited in claim 28, wherein the peripheral device comprises an option pack.

35. The system as recited in claim 23, wherein the peripheral device comprises a storage device.

36. The system as recited in claim 35, wherein the storage device comprises a hard disk drive.

37. The system as recited in claim 23, wherein the peripheral device comprises a modem.
